(19) United States
(12) Patent Application Publication
(10) Pub. No.: US 2022/0127933 A1
(43) Pub. Date: Apr. 28, 2022

(54) ENERGY STORAGE DEVICES AND VIRTUAL TRANSMISSION LINES

(71) Applicant: Schlumberger Technology Corporation, Sugar Land, TX (US)

(72) Inventors: David Robert Evan Snoswell, Cambridge (GB); Gregory Michael Skoff, Longmont, CO (US)

(21) Appl. No.: 17/509,340

(22) Filed: Oct. 25, 2021

Related U.S. Application Data
(60) Provisional application No. 63/105,383, filed on Oct. 26, 2020.

(51) Int. Cl. E21B 41/00; H02J 7/00

(52) U.S. Cl. CPC E21B 41/0085; H02J 7/00712; H02J 7/0063; H02J 7/0013

(57) ABSTRACT

A virtual transmission line includes a charge location and a discharge location. One or more mobile batteries are charged at the charge location. The mobile batteries are transported to the discharge location. At the discharge location, the mobile batteries are connected to electric equipment. The mobile batteries are then transported back to the charge location and the cycle repeated.

### CROSS-REFERENCE TO RELATED APPLICATIONS

This application claims the benefit of and priority to U.S. Patent Application No. 63/105,383, filed Oct. 26, 2020, the entirety of which is hereby incorporated by this reference in its entirety.

### BACKGROUND

Many developed nations have an extensive power grid. Power is generated at power plants and transmitted along transmission lines to electricity consumers, such as individual homes, businesses, factories, manufacturing plants, construction operations, and so forth. The transmission lines are physical wires that are suspended above the ground, laid on the ground, buried underground, or buried under water.

In some situations, electric equipment may be located out of range of transmission lines. For example, remote construction, mining, drilling, exploration, scientific research, or other operations may include equipment that utilizes a large amount of electric power without ready access to existing transmission lines. In some situations, the installation of physical transmission lines to such remote operations may be both time-consuming and expensive. To provide electric power for a remote operation, generators may generate electricity and may be powered by fossil fuels, such as diesel, gasoline, natural gas, and so forth. In some embodiments, generators may be expensive to own, rent, and/or operate.

As an example, drilling and fracking operations may consume large amounts of fuel in order to power wellsite operations. For instance, diesel generators may be used to power drilling tools such as mud pumps, the draw works, a top drive, pipe handling systems, and the like. Other operations may also utilize diesel fuel. For instance, in a hydraulic fracturing operation, high-pressure, high-volume pumps and a slurry blender may be powered by diesel generators. These types of operations can have high power requirements. By way of example, the typical average power requirement for a fracking operation in United States can be on the order of 30 MW, and for drilling may be 3 MW.

When the drilled or fractured well is used for production, extracted fluids can include hydrocarbons in the form of crude oil and natural gas. Both fluids may be recovered together and have a variety of different uses. In some areas, a lack pipelines or other transportation infrastructure may limit transport of some of the fluids. For instance, crude oil may be extracted while the gas that also arrives at the surface may be burned as waste in a gas flare.

### SUMMARY

According to some embodiments, a virtual transmission line includes a generator or heat conditioner, at least two mobile batteries, and a transport device. The at least two mobile batteries are each configured to be removably coupled between charge and discharge locations. In the charge location, each of the at least two mobile batteries is coupled to a power generation system. In the discharge location, each of the at least two mobile batteries is coupled to electric equipment. The transport device is configured to move each of the at least two mobile batteries between the charge and discharge locations when the mobile batteries are decoupled from the power generation system and from the electric equipment.

In another embodiment, a method for providing a virtual transmission line includes tracking a location of at least two mobile batteries between charge and discharge locations and planning transfer of the at least two mobile batteries between the charge and discharge locations. This includes considering at least one of a distance between the charge and discharge locations, local traffic between the charge and discharge locations; availability of drivers to move the at least two mobile batteries between the charge and discharge locations; or varying a physical location of at least one of the charge location or the discharge location. The method further includes moving the at least two mobile batteries between the charge and discharge locations in response to planning the transfer.

In another embodiment, an integrated thermal storage device includes a heat transfer mechanism and a vibrating bed coupled to the heat transfer mechanism. A first metal hydride powder storage location is also included along with a second metal hydride powder storage location. The vibrating bed is configured to move metal hydride powder from the first metal hydride powder storage location to the second metal hydride powder storage location.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of a virtual transmission line system, according to at least one embodiment of the present disclosure;

FIG. 2 is a representation of a virtual transmission line system, according to at least one embodiment of the present disclosure;

FIG. 3 is a representation of an operation site map, according to at least one embodiment of the present disclosure;

FIG. 4 is a representation of an operation frequency plot, according to at least one embodiment of the present disclosure;

FIG. 5 is a representation of an example wellsite, according to at least one embodiment of the present disclosure;

FIG. 6-1 and FIG. 6-2 are representations of payback period plots, according to at least one embodiment of the present disclosure;

FIG. 7-1 and FIG. 7-2 are representations of payback period plots, according to at least one embodiment of the present disclosure;

FIG. 8 is a flowchart of a method for providing a virtual transmission line, according to at least one embodiment of the present disclosure;

FIG. 9 is a flowchart of a method for providing a virtual transmission line, according to at least one embodiment of the present disclosure;

FIG. 10 is a representation of a vibrating plate, according to at least one embodiment of the present disclosure;

FIG. 11 is a representation of a metal hydride charging system, according to at least one embodiment of the present disclosure;

FIG. 12 is a flowchart of a method for transporting hydrogen, according to at least one embodiment of the present disclosure; and

FIG. 13 is a flowchart of a method for transporting hydrogen, according to at least one embodiment of the present disclosure.

### DETAILED DESCRIPTION

Embodiments of the present disclosure relate generally to systems for creating a virtual transmission to provide power to remote operations. In a virtual transmission line, mobile batteries or other power storage devices may be charged (e.g., energy may be added) at a charge location. When the batteries are charged, they may be routed to a discharge location. At the discharge location, the batteries may be connected to electric equipment. Use of the electric equipment may drain the batteries, and the batteries may be routed back to a charge location. This process may be repeated indefinitely until the power needs at the remote operation have been met. A virtual transmission line may help to reduce diesel consumption on site, thereby reducing carbon emissions. Because large-scale power generation is often more efficient than power generation using a diesel generator, the virtual transmission line may help to reduce power generation costs, thereby saving the operator money.

In some embodiments, a charge location may be any location that has a reliable power source of sufficient size or capacity to charge the mobile batteries. The power source at a charge location may be any power source. For example, the power source may be a connection to a transmission line. The connection to the transmission line may receive power from the grid that is remote from the location where the power is generated. The power source and/or the connection to the transmission line may include any necessary transformers, regulators, fuses, circuit breakers, and other electrical control equipment to allow for the safe charging of the mobile batteries. In some examples, the power source may include a power generator. For example, the power source may be a fossil fuel powered power plant. In some examples, the power source may be a solar power array or a solar power plant. In some examples, the power source may be a wind power plant. In some examples, the power source may be any other type of power source, including geothermal, hydroelectric, any other power source, and combinations of the power sources described herein.

In some embodiments, a discharge location for a mobile battery may be any location at which the mobile battery is discharged. In some embodiments, a discharge location may be located at a remote operation. In some embodiments, a discharge location may be at a location that is connected to the electric grid, but where additional or alternate power may be necessary. For example, a mobile battery at a discharge location may provide backup power, to be used if the power supply is interrupted. In some examples, the mobile battery may provide auxiliary power in the event that the infrastructure from the power grid is insufficient to meet the power consumption of the electric equipment and/or spikes in power consumption of the electric equipment.

In at least one example, the mobile batteries may be charged using energy generated by flaring gas. More particularly, embodiments of the present disclosure relate to capturing energy in reusable storage devices that can then be independently moved between different locations, including between different well sites. The storage devices may be decoupled from the energy capture system to facilitate transport.

In accordance with embodiments of the present disclosure, a remote operation may be any operation that utilizes electric equipment that is not connected to the power grid. Put another way, remote operations may not be connected to one or more transmission lines and rely on remote or mobile power sources. Examples of remote operations include drilling rigs, construction sites, mining sites, exploration sites, scientific research stations, weather operation stations, military operating bases, any other remote operation, and combinations thereof. In some embodiments, a remote operation may be less than a kilometer (km), 1 km, 2 km, 5 km, 10 km, 25 km, 50 km, 75 km, 100 km, 250 km, 500 km, 1,000 km, 2,500 km, 5,000 km, or further from a power source.

In regions such as the Permian basin in west Texas, field operations may be within fifty miles (80.5 km) of production sites where associated gas produced by a well is flared. Although there are many technologies to capture or use associated gas it remains challenging to implement these technol for site operations because there is no economic method of transferring the energy. In some embodiments, the mobile batteries discussed herein include large mobile lithium batteries that can be transported by road to transfer energy between associated gas field generators and field operations. Calculations suggest the replacement of diesel generators by this method is not only feasible but potentially highly profitable.

In these same regions, individual gas flares may burn off excess gas. Such gas flares typically range from 0.5 to 5 million standard cubic feet per day (MMcfd) in capacity, the equivalent of 6 to 63 MW output, respectively. This energy is largely lost. Accordingly, aspects of the present disclosure include systems and methods for collecting a flare gas and generating electricity in real time. Further aspects of the present disclosure include systems and methods for providing secondary usage of the generated electrical power generated. Further systems and methods may provide portable assemblies and logistics systems to enhance mobility and implement the system within a plurality of sites.

Roughly 2% of oil production is used to power the oil and gas extraction process in the United States. With approximately 1,200 land rigs operating and each using 1,500 gal/day of diesel, the total energy cost to run operations can be on the order of $7 million per day.

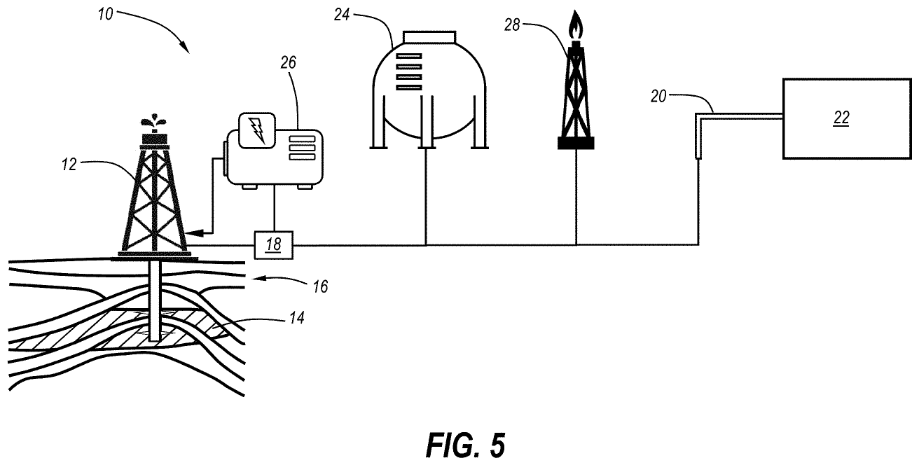

Simultaneously, associated gas produced during oil production is often stranded from gas collection pipelines and so is flared, as discussed herein with respect to FIG. 5. Due to the temporary nature of operations and the high energy cost of compressing methane, it is often not economic to recover this energy. One solution is to run electric generators from the associated gas; however, laying a temporary electrical transmission line to wellsites is often not practical.

To provide an economic transportation mechanism for energy that works even for operations that move frequently, and as discussed herein, embodiments of the present disclosure relate to a virtual transmission line, in which road transport of large-scale energy storage devices (e.g., mobile batteries) occurs between gas powered generators and nearby rig sites. Such a solution may take advantage of recent trends in lithium battery performance or energy/heat capture materials, including cost reductions, and enables the access to associated gas resources which are currently wasted.

Land operations frequently rely on diesel generators to supply electrical power as they occur in remote locations far from the electrical grid. Further, they are often temporary and remain in place for days or weeks. Diesel generators produce electricity at a cost of approximately $0.24 per kW/hr. For example, four large 1 MW diesel generators can be used for U.S. land rigs. In a particular, non-limiting example, four CATERPILLAR 3512C gensets are rated at 1045 kW. The diesel fuel may be transported to the rig site via road tankers, and a site may maintain a 20,000-gallon diesel tank which may be filled frequently, such as every five days. Average energy use may be between 2.5 and 3.5 MW (e.g., 3.2 MW); however, significant generation capacity is maintained to manage cyclic loads (e.g., draw works, top drive, mud pumps), scheduled maintenance, and to manage the risk of equipment failure.

When wells produce oil, they frequently produce “associated gas”. Ideally this associated gas is collected, processed at a central facility (e.g., facility 22), and the various fractions sold for additional revenue. However, in many locations, a gas collection pipeline is not available and it is not economical to recover the gas. Indeed, large infrastructure projects to extend pipelines can take years to complete. As a consequence, much of the gas may be flared. For example, gas at a conglomeration of wellsite operations may be flared at a large rate of 260 MMcf/d, equivalent to 3 GW of energy. If this energy were used for electrical power generation at a conversion efficiency of 30%, it could potentially power 280 drilling rigs or approximately 28 fracking operations. Even assuming the associated gas is purchased at $0.05/kWhr, replacing diesel gensets could save $5.4 million per day ($900,000×0.25×24).

As discussed herein respect to FIG. 5, the associated gas can itself be captured (e.g., in tank 24 of FIG. 5) and later transported by road. There can, however, be a significant energy cost and capital equipment cost in order to compress and condense the gas. Transporting the lighter fractions such as methane by road can also be done, but to do so safely often requires the use of expensive, high pressure (e.g., 2,500 psi (17,235 kPa)) trailers known as “tube trailers”.

A potentially cleaner option is to use the associated gas at the production site in a generator to produce electricity that can be fed back to the operations. Custom gensets that filter and precondition the associated gas can be used for treating/removing particulates, H₂S, water, or other materials. Generators can be purchased or leased, as can propane tanks to cover outages. Often, full onsite maintenance teams may be in place to maintain operation of the equipment. Where the flare may be miles away from the wellsite itself, there is then a challenge of installing a temporary transmission line to bring the electrical energy to the wellsite.

To limit construction of temporary transmission lines and minimize transportation of the captured gas itself, some embodiments of the present disclosure contemplate use of mobile batteries in order to capture energy from flared gas, and then use the captured energy at the same site or transfer the captured energy to a different wellsite. In this sense, the capture of the energy in a battery, transport (e.g., by road or rail), and use can be considered a virtual transmission line as no additional physical transmission capabilities may be constructed.

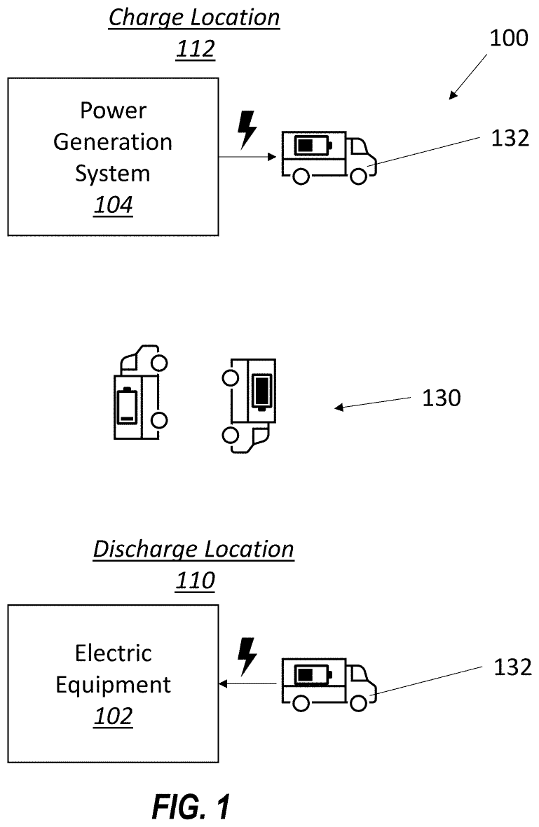

FIG. 1 schematically illustrates an example virtual transmission line system 100 that makes use of mobile batteries 132 to power electric equipment 102 at a discharge location 110. The mobile batteries 132 may be charged from a power generation system 104 at a charge location 112. After the mobile battery 132 is charged at the charge location 112, it may be directed to the discharge location 110. The mobile battery 132 may then be connected to and power the electric equipment 102 at the discharge location 110. When the mobile battery 132 is discharged, the mobile battery 132 may be directed to the charge location 112, where it will be charged at the power generation system 104.

In some embodiments, the charge location 112 may be a wellsite that has a gas flare. The gas flare may burn off the excess waste gas at the charge location 112. The energy from the gas flare may be harvested by using a power generation system 104, such as a flare gas conditioner/generator that optionally runs on waste associated gas and produces electrical or other power that can be used to charge the mobile battery 132.

In some embodiments, the mobile battery 132 may be in the form of a standard shipping container for rail or road (e.g., truck or semi-truck) transport. When the battery 132 is charged, the battery 132 can be transported via an infrastructure network 130 (e.g., a local or national network of roads or railways) and moved to a discharge location 110. At the discharge location 110, the stored power can be used to provide continuous power for a remote operation. In this manner, the mobile battery 132 may be used to replace or supplement diesel generators currently used for wellsite operations.

In accordance with embodiments of the present disclosure, the mobile battery 132 may be transported using an autonomous vehicle or a self-driving vehicle. Driver costs are a significant cost in the shipping of goods. Transporting the mobile battery 132 using autonomous vehicles may help to reduce operating costs of the virtual transmission network. In some embodiments, the mobile battery 132 may be used to power an electric autonomous vehicle.

As shown, the mobile battery 132 may be moved via the infrastructure network 130 between different charge locations 112 and discharge locations 110. In some embodiments, the mobile battery 132 may be used at one wellsite where associated gas is produced or flared, and moved to a separate discharge location 110 where the power is used for a drilling, fracturing, production, or other operation. A depleted battery 132 may then return to the same or other wellsite via the infrastructure network 130 to again be charged. In some embodiments, charging and use of the mobile battery 132 may occur at the discharge location 110. For example, flare gas at the discharge location 110 may be used as a power generation system 104 to charge the mobile battery 132, which may then be used to power electric equipment 102 at the same discharge location. Thus, as may be understood, a single location or remote operation may be both a charge location 112 and a discharge location 110. Put another way, a charge location 112 and/or discharge location 110 may include both a power generation system 104 and electric equipment 102.

With such a virtual transmission line, a discharged mobile battery 132 at the electric equipment 102 could be swapped for a charged mobile battery 132 at the power generation system. Such a system may use multiple batteries to allow charging and depletion to occur simultaneously. Each battery may be separately mobile. Put another way, each battery may be transportable using different equipment or connected to different trailers. For a system including two 4 MWhr batteries operating at 80% depth of discharge and an average total power output of 600 kW, battery swaps could occur 4 to 5 times a day. Such a setup could replace a single 1 MW diesel generator running at 60% average duty cycle. During a swap operation the discharged battery 132 at the wellsite would be changed for a waiting charged battery 132, then the depleted battery 132 would be taken by the infrastructure network 130 to a charge location 112 for charging.

In some embodiments, the mobile battery 132 has a battery size that may be in a range having an upper value, a lower value, or upper and lower values including any of 0.1 MWhr, 0.5 MWhr, 1 MWhr, 2 MWhr, 3 MWhr, 4 MWhr, 5 MWhr, 6 MWhr, 7 MWhr, 8 MWhr, 9 MWhr, 10 MWhr, 11 MWhr, 12 MWhr, or any value therebetween. For example, the battery size may be greater than 1 MWhr. In another example, the battery size may be less than 12 MWhr. In some examples, the battery size may be greater than 12 MWhr. In yet other examples, the battery size may be any value in a range between 1 MWhr and 12 MWhr. In some embodiments, it may be critical that the battery size is greater than 1 MWhr to provide enough power to power the electric equipment 102 at a remote operation.

In some embodiments, a single mobile battery 132 may be located on a single semi-truck trailer. In some embodiments, multiple mobile batteries 132 may be located on a single semi-truck trailer. In some embodiments, a single semi-truck may transport a single mobile battery 132. In some embodiments, a single semi-truck may transport multiple mobile batteries 132, based on the weight and/or size of the mobile batteries. In some embodiments, the semi-truck may be electrically powered, and at least one of the mobile batteries 132 may be used to power the electric semi-truck.

Any suitable battery technology may be used for this virtual transmission line. For instance, lithium ion batteries may be used, particularly where lithium ion battery costs may decrease and/or capacity may increase due to expanded use of electric vehicles. For instance, it may be possible currently to use a super capacitor and lithium battery solid state generator providing 1 to 40 MWhr. In more particular embodiments, a lithium ion battery storage solution that may fit in a standard 40 ft. (12.2 m) shipping container may have a capacity between 1 and 10 MWhr, or in more particular embodiments, between 2 and 8 MWhr or between 3 and 5 MWhr. For instance, a battery with a 4 MWhr battery, if used at an 80% depth of charge, may be expected to run at 6000 cycles at a continuous power rating of 2.5 C (10 MW). Of course, other sizes, capacities, and types of mobile batteries may be used, including other types of batteries as discussed herein.

In at least some embodiments, a charging battery 132 at the charge location 112 may be charged at a higher rate than the discharging battery 132 at the discharge location 110. This may help to account for battery transport and connection time as well as provide some contingency to ensure continuous supply at the discharge location 110. The charging battery 132 would be returned to discharge location 110 before the second battery 132 had depleted, ensuring continuity of power supply.

In accordance with the present disclosure, using mobile batteries 132 at the discharge location 110 may help to reduce costs at the discharge location. Power supply at a remote operation is not constant and is subject to periods of increased power consumption. A diesel-powered generator is usually sized to meet this peak demand, which results in an under-utilization of the generator (e.g., the generator not operating at the maximum capacity). Put another way, a large generator may be purchased or rented at a remote operation to meet peak demand but is used most of the time at a lower capacity. Batteries are well-equipped to meet changing power demands, and the battery is not sized based on peaks in power demand, but rather overall power consumption in MWhrs. In this manner, using the mobile batteries 132 to power the electric equipment 102 may help to reduce costs at a remote operation by reducing the over-sizing of diesel-powered generators.

From an economic standpoint, the system 100 of FIG. 1 could be operated continuously and economically by considering the capital expenditures (sunk costs) required, the payback period, and the annual rate of return on capital. For instance, by replacing two diesel generators with two 4 MWhr batteries, one calculation contemplates 9 battery swaps a day if continuous output is assumed to be 1.2 MW. Capital expenditures on a gas generator are also offset by the saving on 2 diesel generators and considering diesel fuel rates and associated gas costs which may cover operating expenses on the charging generator such as gas pre-treatment and maintenance.

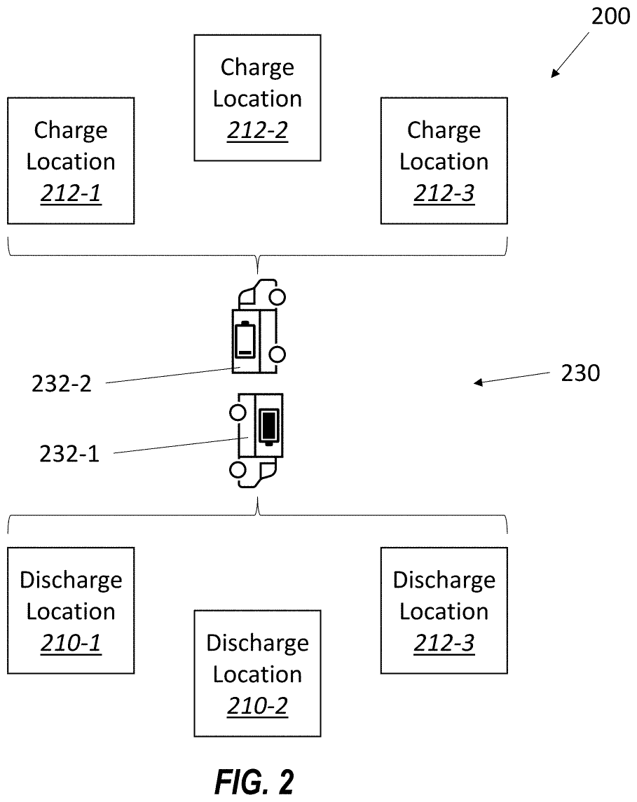

FIG. 2 is a representation of a virtual transmission line system 200 including multiple charge locations (collectively 212) and multiple discharge locations (collectively 210), according to at least one embodiment of the present disclosure. In the virtual transmission line system 200 shown, charged mobile batteries 232-1 may be directed to one of the plurality of discharge locations 210. When the charged mobile battery 232-1 is depleted at the discharge location 210, the discharged mobile battery 232-2 may be directed to one of the plurality of charge locations.

The mobile batteries (collectively 232) may be directed to the various discharge locations 210 and charge location 212 using an infrastructure network 230. The infrastructure network 230 may include any of the elements considered in the transport of the mobile batteries 232 between charge locations 212 and discharge locations 210. For example, the infrastructure network 230 may include the physical pathways along which the mobile batteries 232 may be transported, including the roads, railways, oversea (or lake) shipping, and so forth. In some embodiments, the infrastructure network 230 may include other shipping elements, including the distance between the charge location 212 and the discharge locations 210, local traffic conditions (including traffic at particular times during the day), availability of drivers to transport the mobile batteries 232, availability of driverless vehicles to transport the mobile batteries 232, the power needs of the discharge locations 210 (e.g., the electric duty cycle of the electric equipment), the power generation capacity of the charge locations 212, the charge time at the charge location 212, the discharge time at the discharge location 210, any other infrastructure element, and combinations thereof.

In some embodiments, a mobile battery 232 may be charged at a first charge location 212-1. A dispatcher may analyze the infrastructure network 230 and direct the charged mobile battery 232 to a first discharge location 210-1. In some embodiments, the first discharge location 210-1 may be the closest discharge location 210 to the first charge location 212-1. In some embodiments, a second discharge location 210-2 and/or a third discharge location 210-3 may be closer to the first charge location 212-1, but the analysis of the infrastructure network 230 may result in the charged mobile battery 232-1 being directed to the first discharge location 210-1, based on the elements discussed above.

In some embodiments, when the charged mobile battery 232-1 is depleted, a dispatcher may direct the discharged mobile battery 232-2 to a charge location 212. In some embodiments, the discharged mobile battery 232-2 may be directed back to the first charge location 212-1. In some embodiments, the mobile battery 232 may travel exclusively between the first charge location 212-1 and the first discharge location 210-1. In some embodiments, based on the analysis of the infrastructure network 230, the discharged mobile battery 232-2 may be directed to a second charge location 212-2 or a third charge location 212-3. In some embodiments, the depleted mobile battery 232 may be directed to a recharge location. The recharge location may be one of the charge locations 212 that is used to recharge a depleted battery.

As may be seen, a particular mobile battery 232 may be directed to any of the discharge locations 210 and to any of the charge locations 212. A large, interconnected network of charge locations 212 and discharge locations 210 may allow a dispatcher flexibility to charge the mobile batteries 232 at the most effective locations and to provide power to electric equipment at discharge locations 210 based on their power use. This may help to improve the efficiency of the system 200 and to reduce the operating costs of electric equipment.

In some embodiments, a charge rate of the mobile batteries 232 may be greater than a discharge rate of the mobile batteries 232. This may allow for a single charge location 212 to provide mobile batteries 232 for a single discharge location. In some embodiments, the discharge rate may be faster than the charge rate. In some embodiments, more than one charge location 212 may be used to provide mobile batteries 232 for a single discharge location 210.

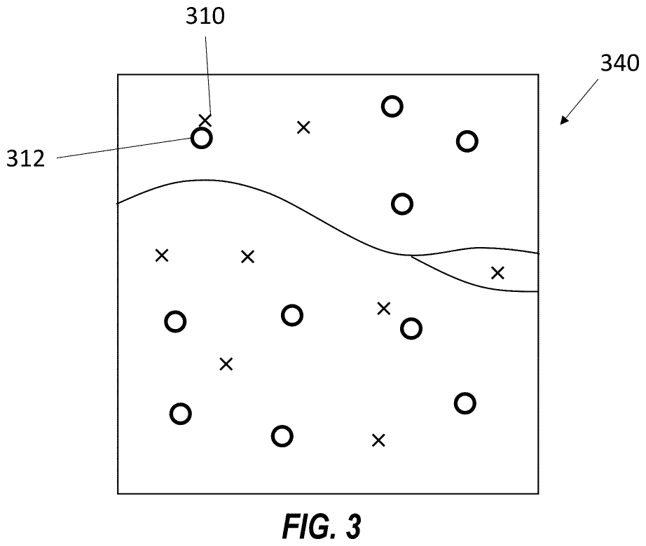

FIG. 3 is a representation of an operation site map 340, according to at least one embodiment of the present disclosure. As may be seen in FIG. 3, some charge locations 312 (illustrated with an 0 mark in the map shown) may be located close to discharge locations 310 (illustrated with an X mark in the map shown). As discussed above with respect to FIG. 2, in some embodiments, charged mobile batteries from a particular charge location 312 may be transported to a nearby discharge location 310. However, based on the infrastructure network, the mobile batteries may be transported between charge locations 312 and discharge locations 310 that are located far apart from each other.

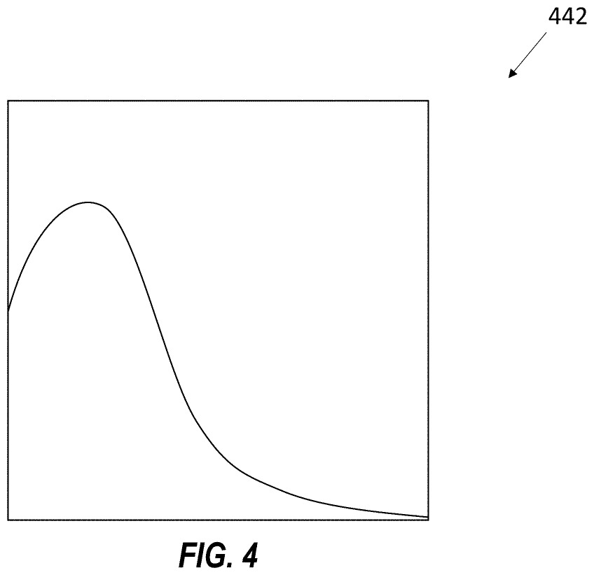

Aspects of the present disclosure relate to the challenge of providing an energy transfer solution from the associated power source to a field operation demand that is flexible and can be deployed at short notice. Deployment of physical infrastructure such as electric grid transmission lines or gas pipelines can take years, whereas remote operations may only operate for days or weeks before crews move to a different site. FIG. 4 is a representation of operation frequency plot 442 with a remote operation duration plotted against the frequency of such remote operations. As may be seen, many remote operations, including in the oil and gas industry operate for a short amount of time. Indeed, as the operation duration gets longer, the frequency of such operations sharply declines. In accordance with embodiments of the present disclosure, a virtual transmission line that includes mobile batteries transported directly to the remote operation may be flexible and responsive to provide power to short-term remote operations.

FIG. 5 illustrates an example wellsite 10 in which surface and/or downhole equipment 12 (e.g., derrick, pumps, artificial lift equipment, valves, pressure control systems) is used to extract hydrocarbons 14 from a subterranean formation 16. When the fluid containing the hydrocarbons 14 reaches the land or subsea surface, the fluid can be processed in myriad ways, including by separating the fluid into different constituents (oil, gas, water, mud), placing the hydrocarbons in storage tanks, or flowing the hydrocarbons through one or more pipelines to a central storage/processing center.

The gas harvested from the wellsite 10 may be used in different manners. FIG. 5 illustrates an example wellsite 10 with multiple uses, although a single one or combination of different uses may be used at a particular wellsite 10. According to one example, gas produced from the wellsite 10 is conveyed to harvesting equipment 18 (e.g., separators, pumps, compressors, condensers, filters, preconditioners). Once harvested, the gas can be used or moved, including through a conveyance system (e.g., land transport/trucks, a pipeline 20) to a central processing facility 22. This type of system uses one or more pipelines 20, road transport, or other equipment which can have limited capacity, and which may not readily be available in all locations or at all times. Different liquid or gaseous materials (e.g., methane, propane) may be separated prior to transport, or may be transported in a combined state.

In some cases, the gas produced from the wellsite 10 is harvested by the harvesting equipment 18 and stored in storage tanks 24. By way of illustration, natural gas (e.g., propane) can be liquified and stored in tanks 24, which reduces the volume of the gas (e.g., by up to 90%) and facilitates road transport of the gas.

In other cases, gas may be moved to an on-site (or nearby) generator 26 by means of a short pipeline or similar conveyance. Using this equipment, the gas may be burned in the generator to produce energy that can replace or supplement diesel generators used to power wellsite equipment. Often, however, wellsite operations move frequently (e.g., every 10 to 20 days). Accordingly, preparing pipelines for such operations may be impractical, especially where gas pipelines can be expensive and can take years to plan.

Another option is to harvest the gas at harvesting equipment 18 and provide the gas to a gas flare 28. The gas flare 28 may burn off the excess or waste gas. In some cases, heat or other energy from the flare may be captured and provided to a local grid. However, as operations may move frequently, the infrastructure for producing the local grid and transmission lines may be prohibitively costly, and the local grid may otherwise become overloaded, making such power/energy transmission financially impractical for some operations.

Although there are many technologies to capture or use produced gas, it can remain challenging to implement them at some sites, because there the methods are not economical. Embodiments of the present disclosure relate to large mobile storage devices (e.g., lithium batteries, lithium ion batteries, metal hydride powders) that can be transported by road to transfer energy between associated gas field generators and field operations. In some embodiments, mobile batteries may not only replace diesel generators but reduce operating costs of a remote wellsite operation.

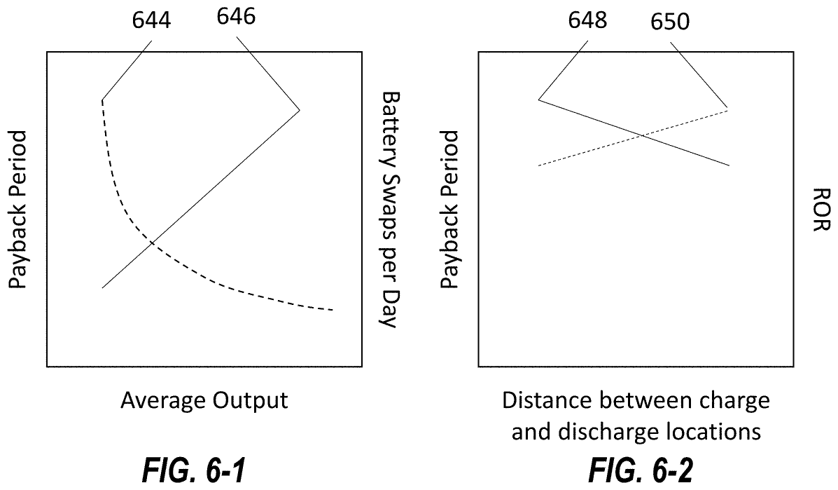

In an example using these considerations, the average output power for a fixed 4 MWhr battery, the distance between charge and discharge locations, the battery costs, and the net fuel savings can be shown to have an effect on return on investment. For instance, FIG. 6-1 is a chart showing output payback plot 644 of battery output plotted against payback period. Also on FIG. 6-1 is a swap output plot 646 of the number of swaps per day plotted against average output. FIG. 6-2 is a chart showing distance payback plot 648 of distance between charge and discharge locations plotted against payback period. Also on FIG. 6-2 is a rate of return (ROR) plot 650 of ROR plotted against distance between charge and discharge locations.

From these observations, it can be seen that the average power output of the battery system has a strong influence on the payback period. Put another way, a higher battery output may be associated with or result in a faster payback period. In this manner, the revenue can be based on the net energy savings for accessing a very low cost fuel instead of diesel. The higher the rate of use, the faster the capital cost of the batteries can be recouped. In fact, batteries as discussed herein could easily supply the entire rig demand for short periods. In practice, the rig load may not be expected to exceed a particular load (e.g., 4 MW) which is the typical combined rating of the existing diesel generators.

The financial impact of driving/moving farther to get batteries recharged shown in FIG. 6-2 may be relatively low as compared to the average output in FIG. 5-1. In this example, an upper limit on distance can be approximated based on a time to recharge the battery and return it to site before the discharging battery is flat.

While lithium battery rates have been falling by 15% per year, even assuming a more conservative rate of 10% decline, a battery pack at a cost of $400 per kWhr will cost $292 per kWhr in 3 years' time. The effect of this cost reduction would lower the payback period from the base case by 25% and increase the rate of return by 35%, as shown in FIG. 6-1. Because battery costs are falling at such a rate, the cost savings may improve over time. It would further be helpful to use a battery's cycle life quickly as the asset will depreciate. In addition, further technology advances are likely to increase volumetric energy density of batteries and so a much larger capacity battery will fit on the same footprint in the future. This will reduce the battery charges per day.

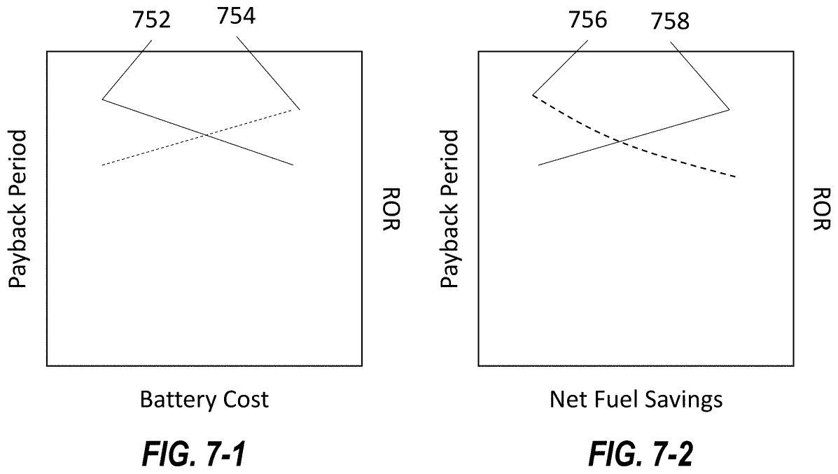

FIG. 7-1 is a chart showing a battery payback plot 752 of battery cost plotted against the payback period. Also shown on FIG. 7-1 is a ROR plot 754 of battery cost plotted against ROR. FIG. 7-2 is a chart showing a fuel savings plot 756 of fuel savings plotted against payback period. Also shown on FIG. 7-2 a ROR plot 758 of net fuel savings plotted against ROR. As may be seen, an increase in battery cost may increase the payback period and reduce the ROR.

The effect of varying the diesel savings is shown in FIG. 7-2, where the “Net fuel saving” on the x-axis is the difference between diesel generator savings and associated gas generator running costs. For FIG. 7-2, the associated gas generator running costs were kept constant and the diesel generator saving were varied from $0.29 to $0.22 per kWhr to simulate realistic changes in diesel fuel costs. The effect is quite significant in this small range and can change the payback period by 50%. In practice, fuel represents approximately 85% of the running cost of generators.

As discussed, flaring of associated gas wastes energy that could be used to power nearby field operations. Lithium ion batteries can have a size, cost, and durability that makes it feasible to create a virtual transmission line by swapping large mobile batteries using road/rail transport between nearby charging and discharging sites. The cost benefits of being able to use cheap flare gas and displace diesel generators are significant.

Indeed, the increases in cost or consideration of managing a significant time-sensitive logistics operation, extra traffic on local roads, managing access to flare gas and nearby drilling sites, and maintaining an associated gas generator and charge point may be offset by other considerations. Such considerations may include large reductions in diesel fuel cost (payback <3 years, rate of return >20%), reduced diesel emissions and noise on drilling site, reduced carbon footprint of operations, higher peak capacity (MW) than 100% diesel generators, increased environmental visibility with clients, and expansion of potential markets beyond oil and gas.

Furthermore, future trends can further improve financial returns. For instance, lower battery costs, higher volumetric energy density, larger capacity batteries on trailer, regeneration of battery packs with new cells, reduced cost of continuing operation, autonomous driving, and electric powered semi-trailers may increase financial viability of a virtual transmission line.

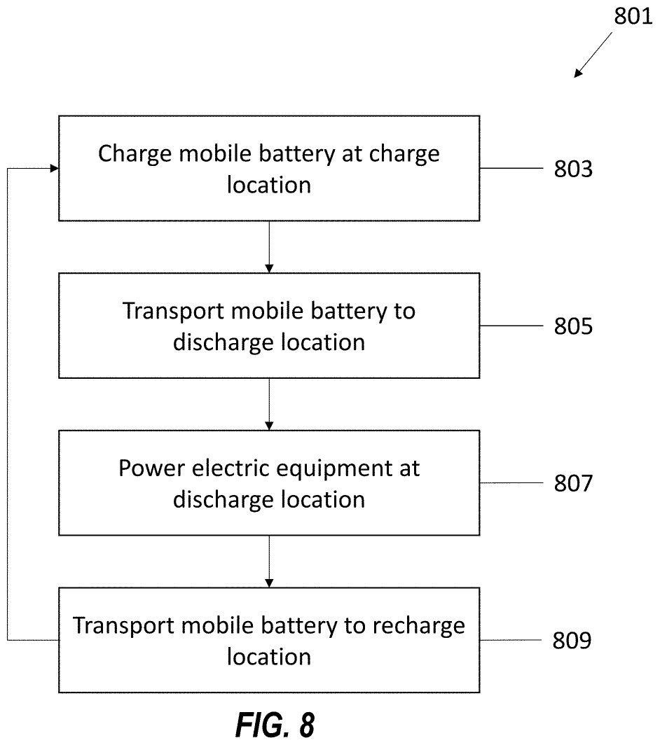

FIG. 8 is a flowchart of a method 801 for providing a virtual transmission line, according to at least one embodiment of the present disclosure. The method 801 includes charging one or more mobile batteries at a charge location at 803. In some embodiments, the mobile battery may be charged at a power generation system at the charge location. When the mobile battery is charged, the mobile battery may be transported from the charge location to the discharge location at 805. The electric equipment may be powered at the discharge location at 807. In some embodiments, when the mobile battery is discharged, it may be transported to a recharge location at 809. The mobile battery may then be charged again and the method 801 repeated indefinitely the remote operation at the discharge location is completed.

In some embodiments, the method 801 may include identifying the discharge location from a plurality of discharge locations. In some embodiments, the recharge location may be the same as the charge location. In some embodiments, when the mobile battery is recharged, the mobile battery may then be transported to the discharge location. In some embodiments, the mobile battery may be charged while it is connected to a semi-truck trailer.

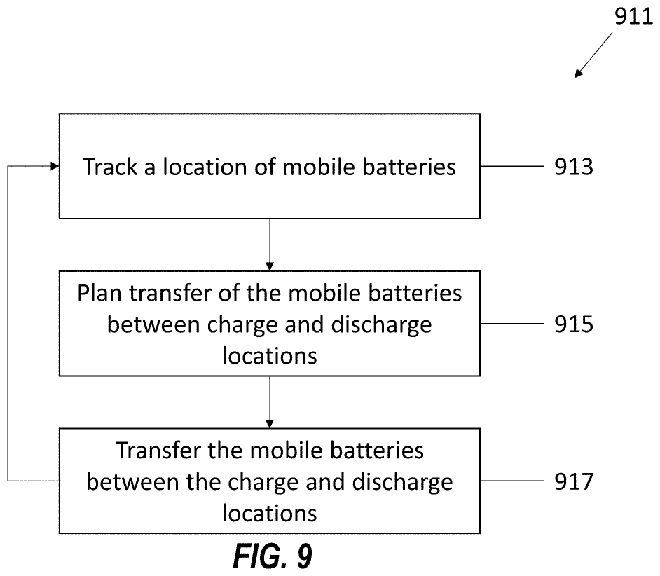

FIG. 9 is a flowchart of a method 911 for providing a virtual transmission line, according to at least one embodiment of the present disclosure. The method 911 may include tracking a location of at least two mobile batteries at 913. The location of the at least two mobile batteries may be any location at or between a charge location or discharge location. In some embodiments, a dispatcher may plan transfer of at least two mobile batteries between the charge and discharge locations at 915. In some embodiments, transfer of the mobile batteries may be planned by considering at least one of: a distance between the charge and discharge location, local traffic between the charge and discharge locations, the availability of drivers to move the at least two mobile batteries between the charge and discharge locations; varying a physical location of at least one of the charge location or the discharge location, a charge time at the discharge location, a discharge time at the discharge location, a projected power usage at the discharge location, any other consideration, and combinations thereof. In some embodiments, the method 911 may include transferring the at least two mobile batteries between the charge and discharge locations in response to planning the transfer location. In some embodiments, the charge and discharge locations may be different.

In some embodiments, the method 911 may be performed using one or more computing systems. For example, a computing system may include a virtual transmission line dispatch system. The dispatch system may receive information regarding battery transportation systems. For example, the dispatch system may receive information regarding the status of the mobile batteries within the virtual transmission line, the location of mobile batteries within the virtual transmission line, the availability of drivers, the availability of autonomous vehicles, traffic conditions, local rules and regulations, the location of discharge locations, the power consumption of discharge locations, the location of charge locations, the capacity of charge locations, any other information, and combinations thereof. The dispatch system may automatically route the mobile batteries between the discharge locations and the charge locations based on the considered factors. In some embodiments, the dispatch system may provide recommended routes for the mobile batteries, which may be reviewed by a human operator. In this manner, a large and complex virtual transmission line may be managed using the dispatch system on the computing system.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on- demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

In some embodiments, heat may be transferred in hydride powders, and the heat can provide energy that is accessed with integrated thermal storage for hydride powder hydrogen charging/discharging.

By way of example, metal hydride powders can be used for hydrogen storage at low pressure. Adsorption and desorption of hydrogen is accompanied by a thermal process, during which adsorbed heat is generated and subsequently removed. During desorption, heat is input and could account for 20% of the energy contained within the hydrogen gas desorbed.

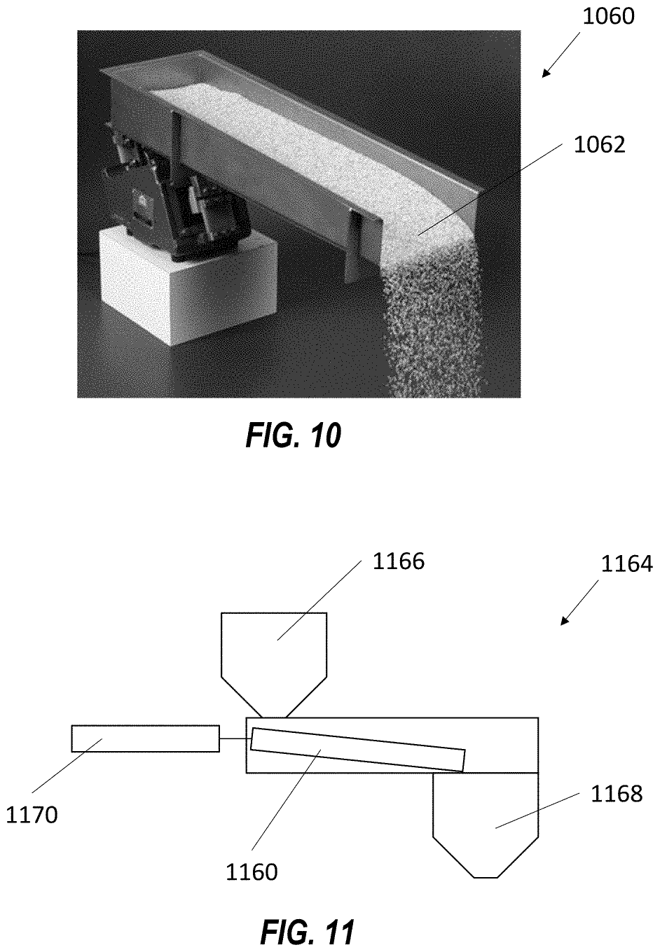

Metal hydride powders used for hydrogen storage can be contained within a low-pressure vessel (e.g., less than 10 bar) containing a heat exchanger. The hydride powder storage vessel can be separated from the heat exchanger and contact the powder during powder transfer between two vessels. One or more vibrating plates 1060 may be used to control the powder flow of metal hydride powder 1062 from hoppers as shown in FIG. 10.

In an embodiment using metal hydride powders, a heat exchanger can be incorporated within the vibrating plate. FIG. 11 is a representation of a metal hydride charging system 1164, according to at least one embodiment of present disclosure. The metal hydride charging system 1164 may include a vibrating plate 1160 is used during metal hydride powder transfer between a first hopper 1166 and a second hopper 1168. In the first hopper 1166 there may be H₂ saturated hydride powder in a charged state, and the powder after transfer to the second hopper 1168 may be H₂ desaturated hydride powder in a discharged state. A heat exchanger (e.g., heat source/sink) 1170 operating with the vibrating plate 1160 may trigger desorption of hydrogen. For example, the heat exchanger 1170 may heat the vibrating plate 1160, thereby heating the metal hydride powder. This may cause the metal hydride powder to release or desorb the hydrogen gas. In a similar manner, the device could be used to extract heat during hydrogen adsorption of metal hydrides.

As discussed herein, in some embodiments, the heat exchanger 1170 may include a heat sink. The heat sink may include a mass of metal or other high heat capacity material. The heat sink may be heated during the production of hydrogen and/or the charging of the metal hydride powder. In some embodiments, the heat sink may be located on the same transport truck as the metal hydride powder. In this manner, the transport truck may transport both hydrogen (in the metal hydride powder) and the heat used to liberate the hydrogen at the discharge location.

In some embodiments, the heat sink in the heat exchanger may absorb heat created during adsorption of hydrogen by the metal hydride powders. In some embodiments, the heat sink in the heat exchanger may be heated by any other mechanism, including electrical resistance, heat from flare gas, solar heat, any other mechanism, and combinations thereof. In some embodiments, the heat sink may discharge its heat to the vibrating plate 1160 at the discharge location to liberate the hydrogen from the metal hydride powder.

In some embodiments, the heat exchanger 1170 may be connected to an electrolysis system. For example, the heat exchanger 1170 may be connected to a solid oxide electrolysis system. The heat generated by charging the metal hydride powder may be collected by the heat exchanger 1170 and used to heat steam used in solid oxide electrolysis. Heating the steam using the excess heat from charging the metal hydride powder may increase the efficiency of electrolysis while simultaneously collecting and removing the heat generated by charging the metal hydride powder.

Heat is transferred to the thin powder bed during hydrogen desorption by direct contact with the plate surface of the vibrating plate 1160. The first hopper 1166, the second hopper 1168, the vibrating plate, 1160, and heat exchanger 1170 may be enclosed within a low pressure vessel (less than 10 bar). In some embodiments, an external heat source may be thermally connected to the vibrating plate 1160 via a circulating heat exchange fluid. In some embodiments, heat may be applied to the vibrating plate 1160 in any other manner, such as through resistive coils, inductive heating, flare gas flames, any other manner, and combinations thereof.

In some embodiments, the metal hydride charging system 1164 may be used to charge the metal hydride powder. During hydrogen charging the process is reversed and heat is extracted from the plate as the powder adsorbs hydrogen. For example, discharged metal hydride powder (e.g., metal hydride powder that contains no or little hydrogen) may be introduced into the first hopper 1166. The metal hydride powder may pass from the first hopper 1166 onto the vibrating plate 1160. The vibration of the vibrating plate 1160 may cause the metal hydride powder to pass across the vibrating plate 1160 and into the second hopper 1168. Hydrogen gas may be passed over the vibrating plate 1160. Adsorption of the hydrogen into the metal hydride powder may cause the metal hydride powder to heat up. The heat from the metal hydride powder may be collected from the vibrating plate 1160 and absorbed and/or dispersed by the heat exchanger 1170. In this manner, the metal hydride charging system 1164 may be used to both charge and discharge the metal hydride powder.

In some embodiments, the heat exchanger 1170 could include a diesel exhaust from a genset, a returns mud flow heat exchanger on a drilling rig, a gravel pack, or the like. Metal hydride desorption can be turned over a wide range, including between 60 and 300° C. The described metal hydride heat storage system may be used as an independent storage device or may be used in the virtual transmission line system for flare gas recovery as discussed herein.

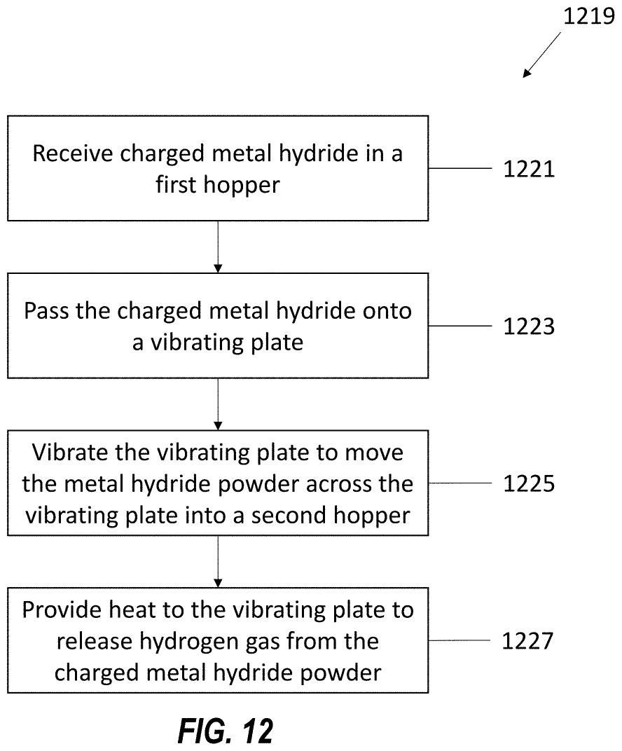

FIG. 12 is a flowchart of a method 1219 for transporting hydrogen, according to at least one embodiment of the present disclosure. In some embodiments, the method 1219 may include receiving charged metal hydride in a first hoper at 1221. The charged metal hydride powder may be passed from the first hopper onto a vibrating plate at 1223. The vibrating plate may be vibrated to move the metal hydride powder across the vibrating plate and into a second hopper at 1225. Heat may be provided to the vibrating plate to release hydrogen gas from the charged metal hydride powder at 1227.

In some embodiments, providing heat to the vibrating plate includes providing heat from a heat transfer device connected to the vibrating plate. In some embodiments, the heat transfer device absorbs heat from burning a flare gas. In some embodiments, the method 1219 may include collecting hydrogen gas in a low-pressure vessel. In some embodiments, the discharged metal hydride powder may be collected in the second hopper. The discharged metal hydride powder may be passed across the vibrating plate while in contact with a charging hydrogen gas. The heat generated by adsorption of the charging hydrogen gas may be transferred to a heat transfer device in contact with the vibrating plate.

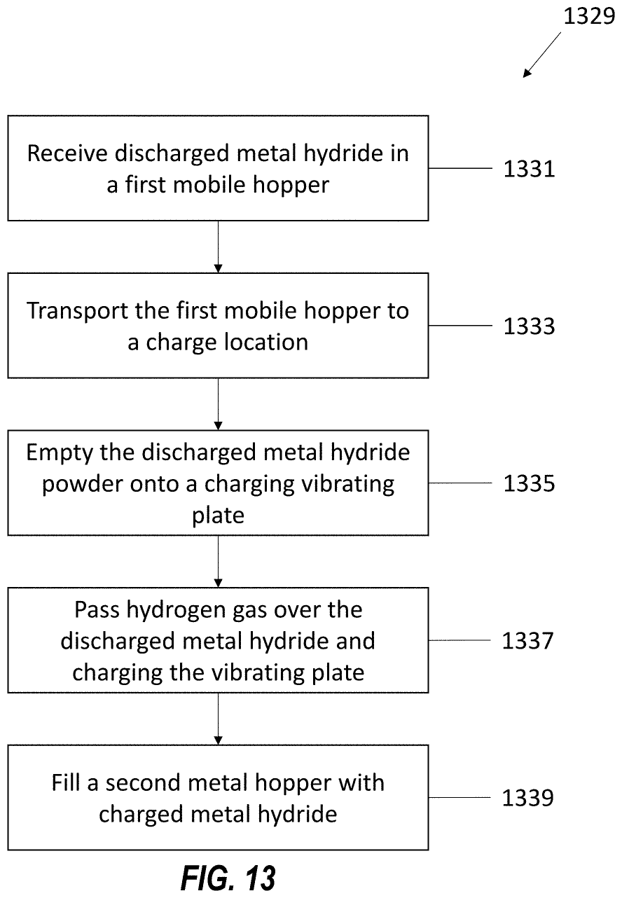

FIG. 13 is a representation of a method 1329 for transporting hydrogen, according to at least one embodiment of the present disclosure. The method 1329 may include receiving discharged metal hydride in a first metal hopper at a discharge location at 1331. The first mobile hopper may be transported to a charge location at 1333. At the charge location, the discharged metal hydride powder may be emptied onto a charging vibrating plate at 1335. Hydrogen gas may be passed over the discharged metal hydride powder and the charging vibrating plate to form charged metal hydride powder at 1337. In some embodiments, a second mobile hopper may be filled with the charged metal hydride powder at 1339.

In accordance with embodiments of the present disclosure, the method 1329 may include absorbing heat generated while charging the metal hydride powder, and providing heat to the metal hydride powder while discharging the metal hydride powder. In some embodiments, the heat may be provided and absorbed by a heat exchanger connected to the vibrating plate.

In some embodiments, heat may be stored and transported with the metal hydride powder. For example, the transport vehicle may transport a heat sink. The heat sink may be a mass of metal or other high heat capacity material. In some embodiments, heat may be provided to the heat sink at the charge location, and the heated heat sink may be transported to the discharge location. At the discharge location, the heat from the heat sink may be used to discharge the metal hydride powder. In this manner, the metal hydride powder and heat sink may transport both hydrogen and the heat used to liberate the hydrogen from the metal hydride powder.

In some embodiments, heat may be applied to the heat sink in any manner. For example, hydrogen may be extracted from a flare using methane pyrolysis. The burning flare may further be used to heat the heat sink on the transport truck. In this manner, the flare gas may be used to both generate the hydrogen and provide the heat for its release from the metal hydride powder.

In some embodiments, the second mobile hopper may be transported to the discharge location. At the discharge location, the hydrogen gas may be collected from the charged metal hydride powder. In some embodiments, collecting the hydrogen gas may include emptying the charged metal hydride powder onto a discharging vibrating plate and heating the discharging vibrating plate to release the hydrogen gas from the discharged metal hydride powder. In some embodiments, the charging vibrating plate and the discharging vibrating plate are the same. In some embodiments, both the first and second hoppers are transported simultaneously on the same semi-truck trailer.

Following are sections in accordance with embodiments of the present disclosure:
A1. A method for providing a virtual transmission line, comprising:
   receiving a discharged metal hydride powder in a first mobile hopper at a discharge location;
   transporting the first mobile hopper to a charge location;
   at the charge location, emptying the discharged metal hydride powder onto a charging vibrating plate;
   passing hydrogen gas over the discharged metal hydride powder and the charging vibrating plate to form charged metal hydride powder; and
   filling a second mobile hopper with the charged metal hydride powder.
A2. The method of section A1, further comprising:
   transporting the second mobile hopper to the discharge location; and
   at the discharge location, collecting the hydrogen gas from the charged metal hydride powder.
A3. The method of section A2, wherein collecting the hydrogen gas includes:
   emptying the charged metal hydride powder onto a discharging vibrating plate; and
   heating the discharging vibrating plate to release the hydrogen gas from the charged metal hydride powder.
A4. The method of section A3, wherein the charging vibrating plate and the discharging vibrating plate are the same.
A5. The method of any of sections A1-A4, wherein transporting the first mobile hopper to the charge location includes transporting the second mobile hopper to the second location.
A6. The method of section A5, wherein transporting the first hopper and the second hopper to the charge location includes transporting the first hopper and second hopper on the same semi-truck trailer.
B1. An integrated thermal storage device, comprising:
   a heat transfer mechanism;
   a vibrating bed coupled to the heat transfer mechanism;
   a first metal hydride powder storage location; and
   a second metal hydride powder storage location, where the vibrating bed is configured to move metal hydride powder from the first metal hydride powder storage location to the second metal hydride powder storage location.
B2. The integrated thermal storage device of section B1, wherein the heat transfer mechanism receives heat from a flare gas.
B3. The integrated thermal storage device of section B1 or B2, wherein the heat transfer mechanism includes a diesel exhaust from a generator.
B4. The integrated thermal storage device of any of sections B1-B3, wherein the heat transfer mechanism is integrated with the vibrating bed.
B5. The integrated thermal storage device of any of sections B1-B4, wherein the heat transfer mechanism operates with metal hydride powders at temperatures between 60° C. and 300° C.
B6. The integrated thermal storage device of any of sections B1-B5, wherein the heat transfer mechanism is configured to absorb heat from metal hydride powder and transfer heat to the metal hydride powder.
B7. The integrated thermal storage device of any of sections B1-B6, wherein the first metal hydride powder storage location and the second metal storage location are low-pressure vessels.
B8. The integrated thermal storage device of section B7, wherein the low-pressure vessels have a pressure of less than 10 bar.
B9. The integrated thermal storage device of any of sections B1-B8, wherein the heat transfer mechanism, the vibrating bed, the first metal hydride powder storage location, and the second metal hydride storage location all fit on a single semi-truck trailer.
C1. A method for transporting hydrogen, comprising:
   receiving a charged metal hydride powder in a first hopper;
   passing the charged metal hydride powder from the first hopper onto a vibrating plate;
   vibrating the vibrating plate to move the metal hydride powder across the vibrating plate and into a second hopper; and
   providing heat to the vibrating plate to release hydrogen gas from the charged metal hydride powder.
C2. The method of section C1, wherein providing heat to the vibrating plate includes providing heat from a heat transfer device connected to the vibrating plate.
C3. The method of section C2, wherein the heat transfer device absorbs heat from burning a flare gas.
C4. The method of any of sections C1-C3, further comprising collecting the released hydrogen gas in a low-pressure vessel.
C5. The method of any of sections C1-C4, further comprising:
   collecting discharged metal hydride powder in the second hopper;
   passing the discharged metal hydride powder across the vibrating plate while in contact with a charging hydrogen gas; and
   transferring heat generated by adsorption of the charging hydrogen gas from the discharged metal hydride to a heat transfer device in contact with the vibrating plate.

As a reference, the terms “couple,” “coupled,” “connect,” “connection,” “connected,” “in connection with,” and “connecting” refer to “in direct connection with” or “in connection with via one or more intermediate elements or members.” In the claims, means-plus-function clauses are intended to cover the structures described herein as performing the recited function and not merely structural equivalents, but also equivalent structures. It is the express intention of the applicant not to invoke functional claiming for any limitations of any of the claims herein, except for those in which the claim expressly uses the words “means for” or “step for” together with an associated function.

Although a few example embodiments have been described in detail above, those skilled in the art will readily appreciate that many modifications are possible in the example embodiments without materially departing from the scope of the present disclosure. Accordingly, any such modifications are intended to be included within the scope of this disclosure.

What is claimed is:

1. A virtual transmission line, comprising:
a power generation system at a charge location;
at least two mobile batteries each configured to be removably coupled between the charge location and a discharge location, wherein:
in the charge location, each of the at least two mobile batteries is connected to the power generation system for charging; and
in the discharge location, each of the at least two mobile batteries is connected to electric equipment; and
a transport device configured to move each of the at least two mobile batteries between the charge and discharge locations when not connected to the power generation system and from the electric equipment.

2. The virtual transmission line of claim 1, wherein the power generation system includes a gas flare.

3. The virtual transmission line of claim 1, wherein the electric equipment includes wellsite equipment.

4. The virtual transmission line of claim 3, wherein the wellsite equipment includes at least one of a mud pump, a draw works, a top drive, or a pipe handling system.

5. The virtual transmission line of claim 1, wherein each of the at least two mobile batteries has a capacity of at least 3 MW.

6. The virtual transmission line of claim 1, wherein each of the at least two mobile batteries has a capacity of at least 4 MWhr providing a continuous power rating of at least 10 MW over 6000 cycles at an 80% depth of charge.

7. The virtual transmission line of claim 1, wherein the power generation system is configured to charge the at least two mobile batteries at a rate greater than a discharge rate of the electric equipment.

8. The virtual transmission line of claim 1, wherein the at least two mobile batteries are lithium ion batteries.

9. The virtual transmission line of claim 1, wherein the at least two mobile batteries are connected to a self-driving vehicle.

10. The virtual transmission line of claim 1, wherein the at least two mobile batteries are separately mobile.

11. A method for providing a virtual transmission line, comprising:
tracking a location of at least two mobile batteries between a charge location and a discharge location;
planning transfer of the at least two mobile batteries between the charge and discharge locations by considering at least one of:
a distance between the charge and discharge locations;
local traffic between the charge and discharge locations;
availability of drivers to move the at least two mobile batteries between the charge and discharge locations; or
varying a physical location of at least one of the charge location or the discharge location; and
transferring the at least two mobile batteries between the charge and discharge locations in response to planning the transfer.

12. The method of claim 11, wherein the charge and discharge locations are different.

13. The method of claim 11, wherein the at least two mobile batteries are lithium ion batteries having a footprint configured to fit within a 40 ft shipping container.

14. The method of claim 11, wherein planning transfer of the at least two mobile batteries includes considering a charge time at the charge location.

15. The method of claim 11, wherein planning transfer of the at least two mobile batteries includes considering a projected power usage at the discharge location.

16. A method for providing a virtual transmission line, comprising:
charging a mobile battery at a power generation system at a charge location;
when the mobile battery is charged, transporting the mobile battery from the charge location to a discharge location;
powering electric equipment at the discharge location;
transporting the mobile battery to a recharge location; and
recharging the mobile battery at the recharge location.

17. The method of claim 16, further comprising identifying the discharge location from a plurality of discharge locations.

18. The method of claim 16, wherein the recharge location is the same as the charge location.

19. The method of claim 16, further comprising, when the mobile battery is recharged, transporting the mobile battery to the discharge location.

20. The method of claim 16, wherein charging the mobile battery includes charging the mobile battery while connected to a semi-truck trailer.
